(19) United States
(12) Patent Application Publication
(10) Pub. No.: US 2006/0280070 A1
(43) Pub. Date: Dec. 14, 2006

(54) Radiation source driving device and method for driving a radiation source

(75) Inventor: James Joseph Anthony McCormack, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/550,336

(22) PCT Filed: Mar. 22, 2004
(86) PCT No.: PCT/IB04/50304

§ 371 Date: Sep. 22, 2005

(30) Foreign Application Priority Data
Mar. 27, 2003 (EP) 03100798.2

(51) Int. Cl. G11B 7/12

(52) U.S. Cl. 369/47.5

(57) ABSTRACT

The invention pertains to a radiation source driving device for controlling a voltage fed to a radiation source in an information reproducing system comprising a radiation source controller for controlling the voltage fed to the radiation source, and a power supply for providing a working voltage to the radiation source controller. In prior art systems the working voltage fed to the radiation source controller must be high enough to be able to give enough power to the radiation source in all situations. Thus the working voltage must be equal to a worst case situation wherein the radiation source is fed with a maximum voltage in order to achieve maximum power. In situations wherein the radiation source does not need maximum voltage the working voltage over the control circuit is higher than needs to be for that situation. This extra voltage drop results in power dissipation thereby increasing the temperature of the control circuit and its environment. As increasing speeds require higher radiation powers and the radiation source performance diminishes rapidly with temperature, the temperature control at the radiation source becomes of increasing importance. According to the invention the power supply comprises a control input for controlling the working voltage to the radiation source controller and in that the radiation source driving device further comprises power supply control means for generating a control signal which is fed to the control input of the power supply wherein the control signal is dependent on the voltage fed to the radiation source. If the voltage fed to the radiation source is relatively high, then the radiation source driving device needs a relatively high working voltage to be able to feed the relatively high voltage to the radiation source without the driver output saturating due to the voltage generated across the radiation device. If however the voltage fed to the radiation source is relatively low, then it suffices to feed the radiation source driving device with a relatively low working voltage. By supplying the radiation source driving device with a relatively low working voltage when it does not require a relatively high working voltage, the result is that the average voltage drop over the radiation source driving device is reduced. This has the effect that power dissipation by the radiation source driving device is reduced and therefore the heat generation of the device is reduced.

The invention pertains to a radiation source driving device for controlling a voltage fed to a radiation source in an information reproducing system for reproducing information on an information carrier, comprising

a radiation source controller for controlling the voltage fed to the radiation source, and

a power supply for providing a working voltage to the radiation source controller.

The invention also pertains to a method for driving a radiation source in an information reproducing system for reproducing information on an information carrier, comprising the steps of

controlling a voltage fed to the radiation source by a radiation source controller;

generating a working voltage which is fed to the radiation source controller.

The invention further pertains to a device for recording and/or playback of information on an information carrier.

From WO 01/59896 a control circuit for a radiation source is known. The control circuit can be implemented in an apparatus for reading and/or writing an optical or opto-mechanic information carrier. The apparatus comprises a radiation source for generating a radiation beam. The apparatus also comprises an optical system for mapping the radiation beam at a scanning spot at an information carrier and displacing means for displacing the information carrier and the scanning spot with respect to each other. The control circuit comprises means for generating an error signal which is indicative for a difference between a measured average value of the output power of the radiation source and a desired value of the output power of the radiation source. The control circuit is powered by a power supply. The working voltage fed to the control circuit must be high enough to be able to give enough power to the radiation source in all situations. Thus the working voltage must be equal to a worst case situation wherein the radiation source is fed with a maximum voltage in order to achieve maximum power. In situations wherein the radiation source does not need maximum voltage the working voltage over the control circuit is higher than needs to be for that situation. This extra voltage drop results in power dissipation thereby increasing the temperature of the control circuit and its environment. As increasing speeds require higher radiation powers and the radiation source performance diminishes rapidly with temperature, the temperature control at the radiation source becomes of increasing importance.

It is an object of the invention to provide a radiation source driving device with a relatively low power dissipation. It is a further object to provide a device for recording and/or playback of information on an information carrier comprising such a radiation source driving device. It is also an object to provide a method for driving a radiation source in an information reproducing system with a relatively low power dissipation.

According to the invention the power supply comprises a control input for controlling the working voltage to the radiation source controller and in that the radiation source driving device further comprises power supply control means for generating a control signal which is fed to the control input of the power supply wherein the control signal is dependent on the voltage fed to the radiation source. The radiation source controller uses the working voltage for supplying a voltage to the radiation source.

In accordance with the invention the method for driving a radiation source in an information reproducing system further comprises a step of generating a control signal which controls the working voltage wherein the control signal is dependent on the voltage fed to the radiation source.

If the voltage fed to the radiation source is relatively high, then the radiation source driving device needs a relatively high working voltage to be able to feed the relatively high voltage to the radiation source without the driver output saturating due to the voltage generated across the radiation device. If however the voltage fed to the radiation source is relatively low, then it suffices to feed the radiation source driving device with a relatively low working voltage. By supplying the radiation source driving device with a relatively low working voltage when it does not require a relatively high working voltage, the result is that the average voltage drop over the radiation source driving device is reduced. This has the effect that power dissipation by the radiation source driving device is reduced and therefore the heat generation of the device is reduced. The device according to the invention accomplishes this in the following manner. The control signal is dependent on the voltage delivered to the radiation source. For instance, the control signal could be a digital signal. A first value of the control signal can indicate that the radiation source is turned off and no voltage is supplied to the radiation source. A second value of the control signal then indicates that the radiation source is turned on and a suitable voltage is supplied to the radiation source. The control signal is fed to the control input of the power supply. The power supply then reacts to the control signal by turning off (idle mode) if the control signal has the first value and by turning on when the control signal has the second value. This reduces the power dissipation significantly.

In an other embodiment of the present invention a first value of the control signal indicates that the radiation source driving device reproduces information from the information carrier and a second value of the control signal indicates that the radiation source driving device writes information to the information carrier, and wherein the power supply outputs a first working voltage when the control signal has the first value and the power supply outputs a second working voltage higher than the first working voltage when the control signal has the second value. When reading information from the information carrier, the radiation source requires a relatively low voltage. When writing information to the information carrier, the radiation source requires a relatively high voltage. Therefore the working voltage of the radiation source controller can be lower when reading information with respect to the situation where information is written to the information carrier.

In a further embodiment the control signal is dependent on the relative speed of the information carrier with respect to the radiation source and wherein the working voltage generated by the power supply is a function of the relative speed. When the speed of the information carrier with respect to the radiation source is relatively high, then the radiation beam has to have a relatively high intensity in order to write information to the information carrier. At lower speeds the intensity of the radiation beam can be lower. Therefore, at higher relative speeds of the information carrier the voltage required by the radiation source is relatively high. The control signal can indicate with a first value that a certain speed is exceeded and with a second value that the certain speed is not exceeded. However, the control signal can also be an analog signal of which the amplitude indicates the relative speed of the information carrier. The working voltage provided by the power supply can then be regulated continuously. So, the higher the relative speed, the higher the required voltage of the radiation source, the higher the working voltage.

In an other embodiment the control signal is dependent on a type of information carrier to be read or written and wherein the working voltage generated by the power supply is a function of the type of information carrier. The different types of information carriers require different intensity levels of the radiation beam to be read from or written to. For instance, a CD-RW disc requires a different intensity level then a CD-R disc to write information to the disc. Also, in so called double writers, the information carrier can be a DVD or a CD disc. In that case the different types of information carriers require different radiation sources. For instance, and infrared radiation source (for CD) has a lower working voltage for the same radiation power than a red one (for DVD). Therefore, when it is detected what kind of disc is inserted, then the control signal can indicate what level the working voltage should be. The power supply subsequently reacts to the control signal and adjusts the working voltage to the correct voltage required for the type of information carrier that is inserted.

In a more elaborate embodiment the control signal is a function of two or more parameters such as relative speed, type of information carrier or whether the radiation source driving device reads information from or writes information to the information carrier. More than one parameter can play a role in the required working voltage generated by the power supply. Examples of these parameters are the parameters as mentioned in the previous embodiments, thus relative speed, read or write mode, laser on or off, etc. This has the advantage that the power supply can adapt the working voltage more precisely to the required working voltage.

In a more advantageous embodiment the radiation source driving device further comprises measurement means for measuring a variable which is indicative of the voltage fed to the radiation source and in that the measured variable is fed to the power supply control means, wherein the power supply control means are able to generate the control signal as a function of the measured variable. This embodiment has the advantage that a variable indicating the voltage fed to the radiation source is directly measured and that the control signal controls the working voltage generated by the power supply based on that measurement. This creates a feedback loop which is able to control the working voltage very accurate based on what voltage is required by the radiation source. The measured variable can for example be the voltage over the radiation source or the current fed to the radiation source. Other variables indicating the voltage fed to the radiation source can also be used for the feedback loop.

The radiation source can be driven with a so called write-strategy. A write-strategy can for instance be that the radiation source is not continuously activated when writing but it is modulated with a certain on/off pattern. Also an often used write-strategy is to first activate the radiation source with a relatively high voltage and subsequently with a lower voltage. The material of the information carrier where the pits should be written to is heated up fast in this way. In this case it is important to know the peak voltage at which the radiation source is activated. This because the feedback loop might not be fast enough for following the fast level changes of the voltage fed to the radiation source. In order measure the peak voltage fed to the radiation source it is possible to measure the mean voltage and subsequently calculate the peak voltage (with the knowledge of the write-strategy pattern). Also a circuit which is able to measure the peak voltage can be used. Because such a circuit is well known in the art, it will not be further discussed here.

In a variant of the previous embodiment the power supply control means are arranged to regulate the working voltage to a level equal to a sum of a basic working voltage and a delta working voltage, wherein the basic working voltage is a minimal working voltage at which the radiation source controller is able to feed a required steady state voltage to the radiation source. The behavior of the radiation source can be simulated with a circuit consisting of static elements, such as resistors, and dynamic elements, such as capacitors and coils. When the voltage fed to the radiation source is switched from one level to an other, the dynamic elements cause transient effects. For instance, the voltage and current will have an overshoot. After a certain period the voltage and current will stabilize to a steady state situation. With this embodiment it is possible to control this overshoot. For instance, if the overshoot should be limited, than the delta voltage is regulated to a relatively small level. This has the effect that the voltage cannot increase above the steady state voltage added with the relatively small delta voltage, so that the overshoot is limited. On the other hand, if an overshoot is required, than the delta voltage should be relatively high.

In a variant of the previous embodiment the radiation source controller comprises a field emitting transistor for supplying the voltage fed to the radiation source, the field emitting transistor having a drain-source voltage, wherein the basic working voltage comprises the sum of the drain-source voltage when the field emitting transistor becomes saturated and the required steady state voltage. The field emitting transistor, hereinafter also referred to as FET, has a first region from zero to a certain saturation voltage wherein the drain-source drain-source voltage is increasing linearly with increasing drain-source current and a second region wherein the drain-source current substantially stays constant (slightly increasing) with increasing drain-source voltage. The current and voltage at which the first region transfers to the second region are called the saturation current and saturation voltage. This embodiment has the advantageous effect that when the voltage fed to the radiation source must go, for instance, from relatively low level to a level close to the saturation voltage, that this can be done relatively quickly and with a relatively small overshoot.

The radiation source driving device according to the invention is in particular suitable for application in a device for recording and/or playback of information on an information carrier using a radiation source. In accordance with the invention therefore a device for recording and/or playback of information on an information carrier includes

a radiation source driving device according to the invention;

a radiation source for irradiating a radiation beam on the information carrier, wherein the power to the radiation source is controllable by the radiation source driving device;

mapping means for mapping the radiation beam at a spot at the information carrier;

displacement means for causing a relative displacement between the spot and the information carrier, and

transforming means for transforming a reflected radiation beam into an information signal.

Examples of such devices are CD-R/RW or DVD R/RW recorders, in general all optical players and recorders.

These and other aspects of the invention are described in more detail with reference to the figures. Therein

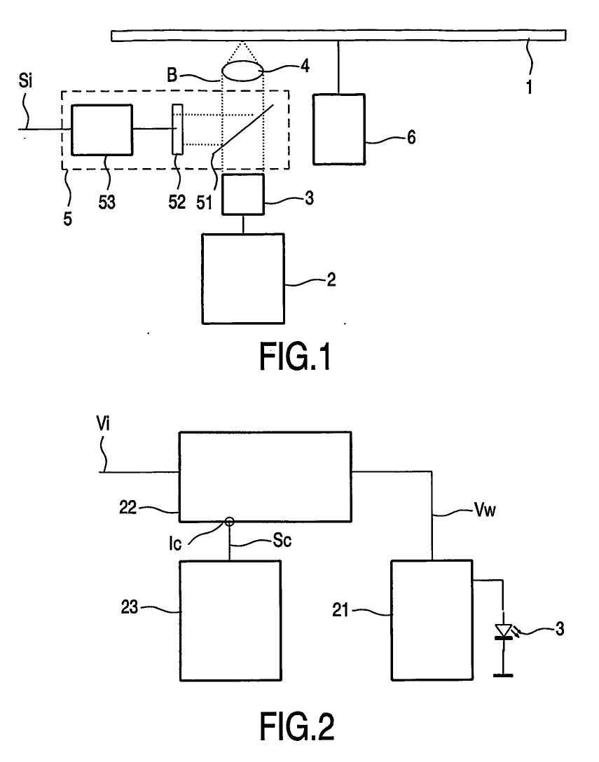

FIG. 1 schematically shows an embodiment of a device according to the invention for recording and/or playback of information on an information carrier,

FIG. 2 schematically shows an embodiment of a radiation source driving device according to the invention,

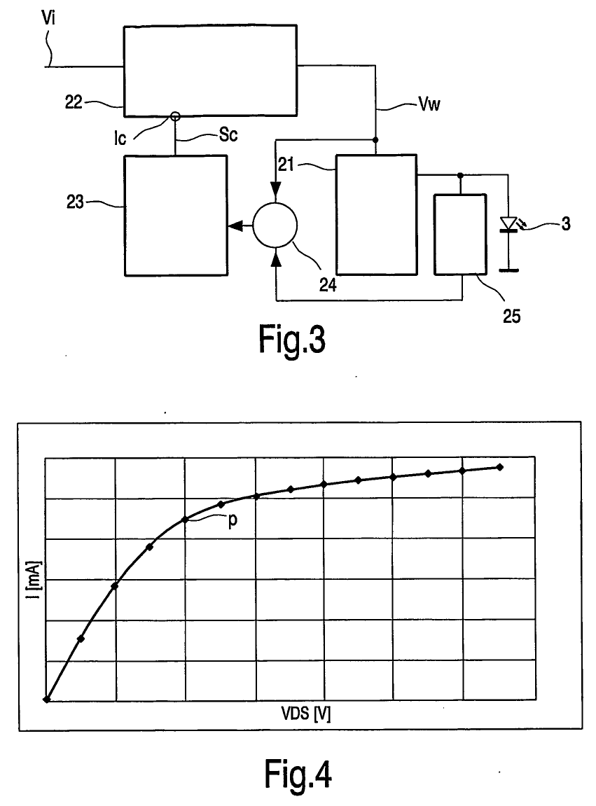

FIG. 3 schematically shows an other embodiment of a radiation source driving device according to the invention, and

FIG. 4 shows an example of an graph of the relation between a the drain-source voltage and the current outputted by a FET.

The embodiment shown in FIG. 1 is an example of an optical recorder which is both suitable for reading and writing. The device comprises a radiation source 3 for generating a radiation beam B. The device also comprises mapping means 4 for mapping the radiation beam at a spot at an information carrier 1 and displacement means 6 for causing a relative displacement between the spot and the information carrier 1. The information carrier 1 in this example is an optical disc such as a CD or DVD disc. The displacement means 6 in this example is a spindle motor which rotates the information carrier 1. The device further comprises transforming means 5 for transforming the reflected radiation beam into an information signal Si. The transforming means 5 in this embodiment comprise a mirror 51 which lets the radiation beam B pass without reflections and which reflects the reflected radiation beam onto a photo detector 52. The photo detector 52 generates an RF signal as a result of the light projected onto the photo detector 52. Subsequently, the RF signal is processed by further circuits 53 which extracts the information signal Si from the RF signal. The further circuits 53 comprise circuits such as an error correction and decoding block well known in the art. As the further circuits 53 are not relevant to the present invention they are not described in detail here. The displacement means can also comprise means for displacing the spot in radial direction with respect to the optical disc. These means may comprise a single stage, in the form of a sledge driven by a linear motor or a rotatable arm driven by voice coil motor. Preferably the radiation spot displacing means comprise another stage for performing small movements, for example in the form of an actuator for controlling a lens in the optical system. In the case of an optical card, the device may comprise displacing means for longitudinally displacing the card, for example a linear motor or a rotating motor movement.

The device shown is provided with a radiation source driving device 2 for controlling the voltage fed to the radiation source 3. As shown in FIG. 2 the radiation source driving device comprises a radiation source controller 21 for controlling voltage to the radiation source 3. To deliver this voltage to the radiation source controller 21 is fed with a working voltage. The power supply 22 generates this working voltage Vw. The power supply 22 is fed with a input voltage Vi which is transformed into the output voltage Vw. The level of the output voltage Vw is dependent on the control signal Sc which is fed at the control input Ic of the power supply 22. The control signal Sc is generated by the power supply control means 23.

The radiation source controller 21 controls the voltage to the radiation source 3 dependent on read or write mode, the information that has to be written to the information carrier 1, speed etc. . . . In prior art systems the working voltage was set at a worst case level, i.e. the maximum required level which conforms with the maximum required voltage fed to the radiation source 3. The power supply 22 in the radiation source driving device according to the invention is capable of varying the working voltage Vw. Wherein the power supply reacts at the control signal Sc. The control signal Sc can be a digital signal. For instance, a logical 0 can indicate that the optical recorder is in read mode and a logical 1 then indicates that the optical recorder is in write mode. In read mode the maximum required working voltage is less than the maximum required working voltage in write mode. The power supply 22 in this case thus reacts to a logical 0 of the control signal by generating a relatively low working voltage Vw and reacts to a logical 1 of the control signal by generating a higher working voltage Vw. This has the consequence that the power dissipation of the radiation source controller 21 is reduced compared to the situation where the working voltage is kept at a constant level which conforms the maximum required voltage fed to the radiation source 3.

In FIG. 3 a preferred embodiment of the radiation source driving device 2 is schematically depicted. The radiation source driving device 2 of this embodiment further comprises measurement means 25 which measures a variable indicative of the voltage fed to the radiation source 3. In this embodiment the voltage over the radiation source 3 is measured. The measured voltage is fed to subtracting means 24 which subtracts the measured voltage from the working voltage Vw. The difference of the working voltage Vw and the measured voltage is fed to the power supply control means 23. The subtracting means 24 can also be incorporated in the power supply control means 23. The power supply control means 23 outputs a control signal which is dependent on the calculated difference. Here the control signal Sc can be digital or analog. For instance, the control signal Sc can indicate with a logical 1 that a certain threshold is passed and the power supply 22 can react to the logical 1 by raising the working voltage Vw with a certain amount. Alternatively, the control signal Sc can be generated analog such that the amplitude level of the control signal Sc is proportional to the calculated difference. The measured variable can also be fed directly to the power supply control means 23 which then generates the control signal Sc proportional to the value of the measured variable. The measurement means 25 can comprise a peak detector for detecting the peak voltage fed to the radiation source 3. Also the measurement means 25 comprise a low pass filter for establishing the mean voltage over the radiation source 3 and subsequently calculate the peak voltage by using knowledge of the write strategy. For instance, if the write strategy is a to vary switch the radiation source 3 on and off with a certain constant duty cycle then the peak voltage has a linear relation with the mean voltage and can be easily calculated with a linear function.

In FIG. 4 the graph can be divided into two regions. One region wherein the FET is not yet saturated and an other region wherein the FET is saturated. In the graph of FIG. 4 point p indicates the point where the FET becomes saturated. In the saturated region the current I increases slightly as a function of the drain-source voltage Vds. At the saturation point p in order to increase in the current I the drain-source voltage Vds must increase with a relatively large amount. When the working voltage Vw is restricted to a level of the drain-source voltage Vds at point p added with the required voltage of the radiation source 3 at steady state, then the drain-source voltage Vds cannot increase above the saturation voltage and therefore restricts the current I. Thus an overshoot is prevented.

It should be clear to a person skilled in the art that the present invention is not limited to the exemplary embodiments discussed above, but that various variations and modifications are possible within the protective scope of the invention as defined in the appending claims.

1. A radiation source driving device (2) for controlling a voltage fed to a radiation source (3) in an information reproducing system for reproducing information on an information carrier (1), comprising
a radiation source controller (21) for controlling the voltage fed to the radiation source (3), and
a power supply (22) for providing a working voltage (Vw) to the radiation source controller (21),
characterized in that the power supply (22) comprises a control input (Ic) for controlling the working voltage (Vw) to the radiation source controller (21) and in that the radiation source driving device (2) further comprises power supply control means (23) for generating a control signal (Sc) which is fed to the control input (Ic) of the power supply (22) wherein the control signal (Sc) is dependent on the voltage fed to the radiation source (3).

2. A radiation source driving device (2) as claimed in claim 1, characterized in that a first value of the control signal (Sc) indicates that the radiation source (3) is turned off and a second value of the control signal (Sc) indicates that the radiation (3) source is turned on, and in that the power supply (22) outputs a first working voltage when the control signal (Sc) has the first value and the power supply (22) outputs a second working voltage higher than the first working voltage when the control signal (Sc) has the second value.

3. A radiation source driving device (2) as claimed in claim 1, characterized in that a first value of the control signal (Sc) indicates that the radiation source driving device (2) reproduces information from the information carrier (1) and a second value of the control signal indicates that the radiation source driving device (2) writes information to the information carrier (1), and wherein the power supply (22) outputs a first working voltage when the control signal (Sc) has the first value and the power supply (22) outputs a second working voltage higher than the first working voltage when the control signal (Sc) has the second value.

4. A radiation source driving device (2) as claimed in claim 1, characterized in that the control signal (Sc) is dependent on the relative speed of the information carrier (1) with respect to the radiation source (3) and wherein the working voltage (Vw) generated by the power supply (22) is a function of the relative speed.

5. A radiation source driving device (2) as claimed in claim 1, characterized in that the control signal (Sc) is dependent on a type of information carrier (1) to be read or written and wherein the working voltage (Vw) generated by the power supply (22) is a function of the type of information carrier (1).

6. A radiation source driving device (2) as claimed in claim 1, characterized in that the control signal (Sc) is a function of two or more parameters such as relative speed, type of information carrier (1) or whether the radiation source driving device (2) reads information from or writes information to the information carrier (1).

7. A radiation source driving device (2) as claimed in claim 1, further characterized by measurement means (25) for measuring a variable which is indicative of the voltage fed to the radiation source (3) and in that the measured variable is fed to the power supply control means (23), wherein the power supply control means (23) are able to generate the control signal (Sc) as a function of the measured variable.

8. A radiation source driving device (2) as claimed in claim 7, characterized in that the measured variable is a measure for the peak voltage over the radiation source (3).

9. A radiation source driving device (2) as claimed in claim 7, characterized in that the measured variable is a current fed to the radiation source (3).

10. A radiation source driving device (2) as claimed in claim 7, characterized in that the power supply control means (23) are arranged to regulate the working voltage (Vw) to a level equal to a sum of a basic working voltage and a delta working voltage, wherein the basic working voltage is a minimal working voltage at which the radiation source controller (21) is able to feed a required steady state voltage to the radiation source (3).

11. A radiation source driving device (2) as claimed in claim 10, characterized in that the radiation source controller (21) comprises a field emitting transistor for supplying the voltage fed to the radiation source (3), the field emitting transistor having a drain-source voltage (Vds), wherein the basic working voltage comprises the sum of the drain-source voltage (Vds) when the field emitting transistor becomes saturated and the required steady state voltage.

12. Method for driving a radiation source (3) in an information reproducing system for reproducing information on an information carrier (1), comprising the steps of
controlling a voltage fed to the radiation source (3) by a radiation source controller (21);
generating a working voltage (Vw) which is fed to the radiation source controller (21),
characterized in that in further comprising a step of generating a control signal (Sc) which controls the working voltage (Vw) wherein the control signal (Sc) is dependent on the voltage fed to the radiation source (3).

13. Method as claimed in claim 12, characterized in that a first value of the control signal (Sc) indicates that the radiation source (3) is turned off and a second value of the control signal (Sc) indicates that the radiation source (3) is turned on, and in that the working voltage (Vw) equals a first voltage when the control signal (Sc) has the first value and the working voltage (Vw) equals a second voltage higher than the first voltage when the control signal (Sc) has the second value.

14. Method as claimed in claim 12, characterized in that a first value of the control signal (Sc) indicates that the information reproducing device reproduces information from the information carrier (1) and a second value of the control signal (Sc) indicates that the information reproducing system writes information to the information carrier (1), and in that the working voltage (Vw) equals a first voltage when the control signal (Sc) has the first value and the working voltage (Vw) equals a second voltage higher than the first voltage when the control signal (Sc) has the second value.

15. Method as claimed in claim 12, characterized in that the control signal (Sc) is dependent on the relative speed of the information carrier (1) with respect to the radiation source (3).

16. Method as claimed in claim 12, characterized in that the control signal (Sc) is dependent on a type of information carrier (1) to be read or written.

17. Method as claimed in claim 12, characterized in that the control signal (Sc) is a function of two or more parameters such as relative speed, type of information carrier (1) or whether the information reproducing system reads information from or writes information to the information carrier (1).

18. Method as claimed in claim 12, characterized in that the method further comprises a step of measuring a variable which is indicative of the voltage fed to the radiation source (3) and wherein the step of generating the control signal (Sc) generates the control signal (Sc) as a function of the measured variable.

19. Method as claimed in claim 18, characterized in that the measured variable is a measure for the peak voltage over the radiation source (3).

20. Method as claimed in claim 18, characterized in that the measured variable is a current to the radiation source (3).

21. A device for recording and/or playback of information on an information carrier (1), the device including
a radiation source driving device (2) as claimed in claim 1;
a radiation source (3) for irradiating a radiation beam (b) on the information carrier, wherein the power to the radiation source (3) is controllable by the radiation source driving device (21);
mapping means (4) for mapping the radiation beam at a spot at the information carrier (1);
displacement means (6) for causing a relative displacement between the spot and the information carrier (1), and
transforming means (5) for transforming a reflected radiation beam into an information signal (Si).
